(19) United States
(12) Patent Application Publication
(10) Pub. No.: US 2015/0282899 A1
(43) Pub. Date: Oct. 8, 2015

(54) Dental System

(71) Applicant: J. Michael Steffen, Oklahoma City, OK (US)

(72) Inventor: J. Michael Steffen, Oklahoma City, OK (US)

(21) Appl. No.: 14/244,281

(22) Filed: Apr. 3, 2014

(51) Int. Cl. A61C 7/36

(52) U.S. Cl. CPC A61C 7/36

(57) ABSTRACT

A dental system may be configured at least with a housing that engages a wire of a first dental assembly. The housing can have first and second portions that are connected via a fastener. A piston may be positioned within the housing and continuously extend from the housing to a mount of a second dental assembly. A compression member can be positioned within the housing to contact the first portion of the housing and the piston to apply continuous pressure on the piston in a selected direction.

### SUMMARY

Various embodiments may configure a dental system to have a housing that engages a wire of a first dental assembly. The housing can have first and second portions that are connected via a fastener. A piston may be positioned within the housing and continuously extend from the housing to a mount of a second dental assembly. A compression member can be positioned within the housing to contact the first portion of the housing and the piston to apply continuous pressure on the piston in a selected direction.

### BRIEF DESCRIPTION OF THE DRAWINGS

FIGS. 1A and 1B respectively show cross-sectional view block representations of portions of example users configured in accordance with various embodiments.

FIG. 2 displays a cross-sectional block representation of a portion of an example mouth configured in accordance with some embodiments.

FIG. 3 is a top view block representation of an example dental system constructed and operated in accordance with various embodiments.

FIG. 4 illustrates an isometric view block representation of an example dental appliance configured in accordance with some embodiments.

FIGS. 5A and 5B respectively show plan view block representations of an example dental appliance constructed in accordance with various embodiments.

FIG. 6 displays a block representation of an example dental appliance configured in accordance with some embodiments.

FIG. 7 provides a perspective view block representation of a dental system arranged in accordance with various embodiments.

FIG. 8 is an example compression member replacement routine that may be carried out in accordance with some embodiments.

### DETAILED DESCRIPTION

Orthodontics has continually been interested in efficient means for altering a person's dental condition. Various procedures and appliances are generally directed to altering teeth of a jawbone in relation to teeth of a skull. While tension members, like rubber bands, can produce orthodontic results over time, the tension members can be prone to user discomfort, failure, and degradation. For example, a user can easily remove one or more rubber bands from the user's mouth for any variety of reasons and fail to replace the bands later on, which can slow and stunt the user's orthodontic progression. Hence, there is an industry and consumer interest in a dental appliance and system that can produce orthodontic results with reduced user discomfort, less user interference, and optimized efficiency.

Accordingly, a dental system can be configured with a housing that engages a wire of a first dental assembly and has first and second portions that are connected via a fastener. A piston may be positioned within the housing and continuously extend from the housing to a mount of a second dental assembly while a compression member is positioned within the housing to contact the first portion of the housing and the piston to apply continuous pressure on the piston in a selected direction. The ability to easily disassemble the first and second portions of the housing while the system is secured in a user's mouth allows for efficient reconfiguration of a user's orthodontic treatment. The connection of the housing to the wire of the first dental assembly, such as dental braces, maintains the dental appliance in the mouth of the user and restricts tampering and removal of the direction and force of compression between the first and second dental assemblies.

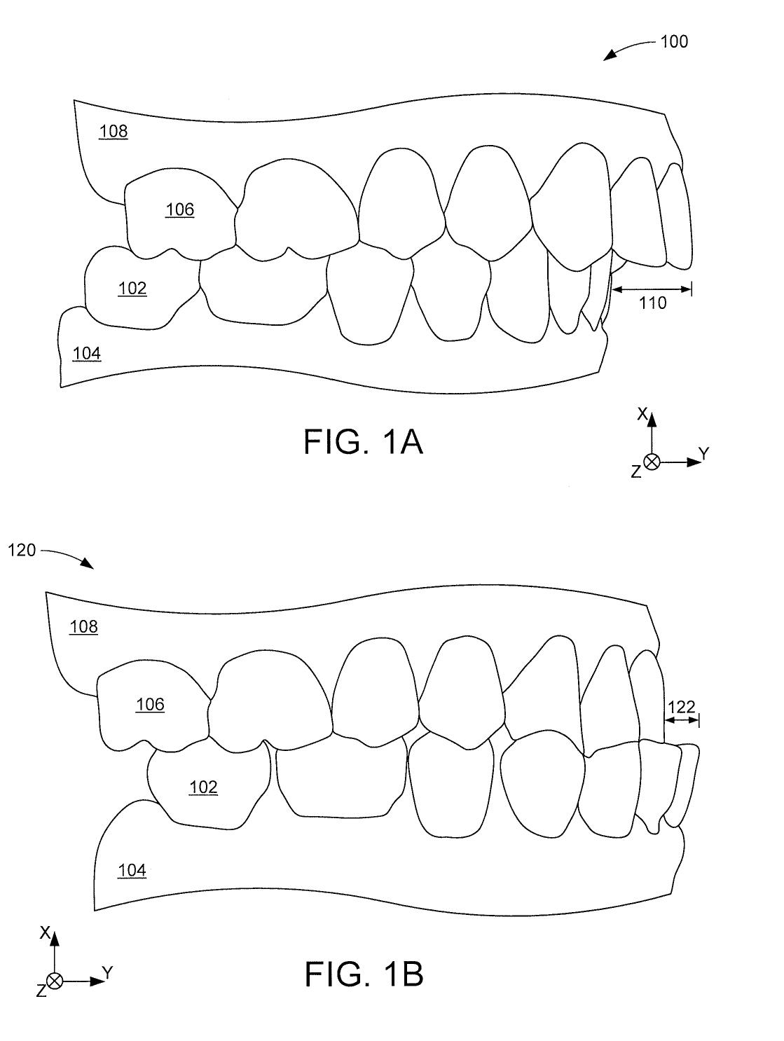

Although the dental system may be utilized to treat and correct an unlimited variety of dental conditions, such as cross-bite and temporomandibular discomfort, assorted embodiments are tuned to correct misalignment of the lower and upper jaws of a user. FIGS. 1A and 1B respectively display cross-section block representations of portions of example users 100 and 120 exhibiting dental conditions in accordance with various embodiments. User 100 of FIG. 1 can be characterized as an over-bite where lower teeth 102 of a lower jaw 104 are misaligned with upper teeth 106 of an upper jaw 108, such as the maxilla of the skull. The protrusion 110 of one or more upper teeth 106 in front of the lower teeth 102 along the Y axis is a malocclusion that can lead to mouth pain, tooth decay, and hampered speech.

FIG. 1B illustrates an under-bite dental condition where the lower teeth 102 extend beyond the upper teeth 106 by a distance 122. The misalignment of the various lower 102 and upper 106 teeth can increase wear on the teeth, alter speech, and cause jaw pain. However, over-bite and under-bite conditions can be treated and cured through the application of pressure to each jaw 104 and 108 in a direction that opposes the tooth misalignment 110 and 122. The treatment of under-bite and over-bite conditions can also be completed via surgery to the muscles and bone of the face, but such invasive procedures commonly render users to elect non-surgical orthodontic treatments.

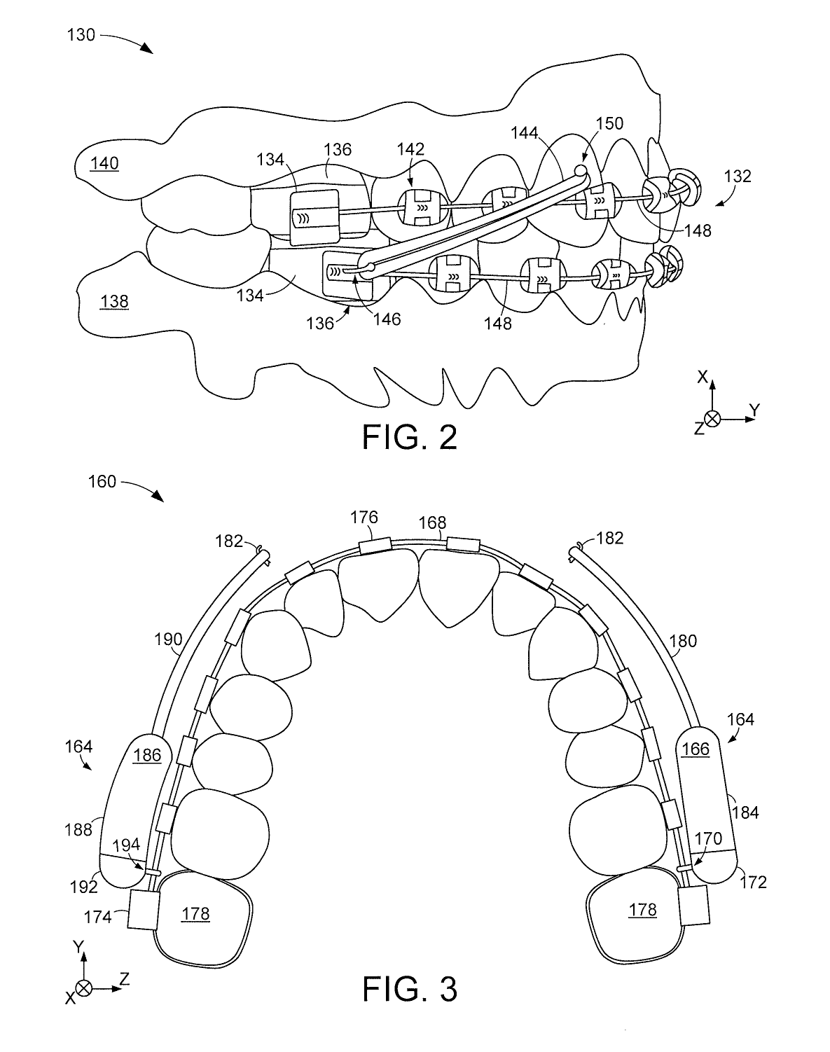

FIG. 2 shows a cross-sectional view block representation of a portion of an example mouth 130 that has a dental condition in accordance with some embodiments. It is contemplated that the dental system 132 present in the mouth 130 can treat a wide range of different dental conditions, such as cross-bite, tooth crowding, and narrow palate, individually and concurrently. The dental system 132 of FIG. 2 is not required or limiting as various aspects can be changed, added, and removed at any time.

As shown, the dental system 132 has bands 134 that surround molar teeth 136 of the lower 138 and upper 140 jaws of the mouth 130. The bands 134 can be any size, material, and position in the mouth 130, but are metal affixed to the respective teeth via glass or composite cement, in assorted embodiments. The increased surface area interface provided by the band 134, as compared to a bracket 142 that is affixed to an exterior surface of a tooth, can provide heightened rigidity and strength that can allow one or more tension members 144 to be anchored. In yet, the increased size and weight of the band 134 compared to a bracket 142 can be uncomfortable for a user and expose tension member 144 attachment means 146, such as a metallic hook, to trauma induced by food and candy.

The function of the band 134 to secure a wire 148 can further position the attachment means 146 towards the cheek and lip of the mouth 130, which can cause discomfort and be prone to trauma. In various embodiments, the wire 148 is flexible by itself, but rigid when affixed to one or more bands 134 and brackets 142 of the dental system 132. The wire 148 can be tuned for material and thickness to induce a predetermined amount of pressure onto the respective teeth of the mouth 130 to translate teeth in various directions. The tension member 144 can likewise be tuned for material, strength, and thickness to provide continuous pressure on the lower 138 and upper 140 jaws in one, or multiple, different directions.

The attachment of the tension member 144 to a selected bracket 142 of the upper jaw 140 can tune manner in which pressure is applied to the mouth 130. That is, the tension member 144 may be attached to upper attachment means 150 of any bracket 142 of any tooth of the upper jaw 140 to apply pressure to the teeth and jaws 138 and 140 along various different axes, such as the X, Y, and Z axis. It is contemplated that an opposite side of the mouth 130 may have a similar or dissimilar configuration of bands 134, brackets 142, and separate tension members 144. While the use of tension members 144 can treat various dental conditions, a number of disadvantages result from the use of the dental system 132 shown in FIG. 2. For example, the tension member 144 can degrade over time due to anticipated and non-anticipated mouth 130 usage and from water absorption from saliva in the user's mouth weakening the pull of the tension member 144. A user may also easily remove the tension member 144 at any time and for any reason. Regardless of the cause, altered tension member 144 application of pressure in the mouth 130 can delay and stunt orthodontic treatment as well as cause user discomfort due to the dental system 132 not functioning as intended.

It is possible to permanently affix means of applying pressure into the dental system, but such techniques have been found to be inefficient as routine modification to the amount of pressure applied to the mouth 130 is common. Moreover, permanent pressure inducing means can malfunction and break, which can result in lengthy and uncomfortable professional repair sessions that can be detrimental to user satisfaction. Therefore, demand for a dental system that allows for efficient routine maintenance while inhibiting user tampering with means for applying pressure between the lower 138 and upper 140 jaws is increasing for industry and consumers alike.

FIG. 3 illustrates a top view block representation of a portion of an example mouth 160 that is afflicted with a dental condition being treated by two differently configured dental appliances 162 and 164 in accordance with some embodiments. Although the mouth 160 is shown with differently configured dental appliances 162 and 164, the concurrent use of different systems is not required or limiting as matching dental appliances can be employed simultaneously in the mouth 160 to provide orthodontic treatment. The first dental appliance 162 is constructed and operated with a body housing 166 that is connected to an archwire 168 portion of dental braces via an eyelet 170 portion of a cap 172 that selectively attaches to the body housing 166.

The eyelet 170 can be any shape, size, and material, but in various embodiments is a circular aperture extending through a protrusion from the housing cap 172. The cap 172 can form a temporary or permanent connection with the housing body 166 in an unlimited variety of fastening manners, such as rivets, magnets, and latches. In assorted embodiments, the cap 172 forms a threaded connection with the housing body 166 to provide a rigid dental appliance body and cap assembly that can withstand trauma and the presence of food particles. The connection of the cap 172 and body 166 assembly with the archwire 168 contrasts connecting a dental appliance with a band 174 or bracket 176 that would restrict movement of the appliance 162 and extend the appliance 162 outward from the teeth 178.

As shown, the eyelet 170 is a continuous compression of the cap 172, which allows the cap 172 to stay attached to the archwire 168 when the body housing 166 is unfastened from the cap 172. That is, the body housing 166 can be selectively removed from the cap 172 to access the inside of the body housing 166 without removing the eyelet from the archwire 168. The ability to perform inspection, maintenance, and repair of the body housing 166 and any components internal to the body housing 166 without removing the eyelet 170 from the archwire 168 allows for efficient inspection, maintenance, and repair of the body housing 166 and any internal components. Conversely, attachment of the cap 170 and/or body housing 166 to the band 174 or bracket 176 would inhibit movement of the mouth 160, such as when talking and eating. As such, it can be appreciated that attachment of the eyelet 170 to the archwire allows for some movement to accommodate movement while inhibiting any removal of and tampering with the dental appliance 162, which can degrade orthodontic treatment.

The body housing 166 and cap 172 can provide a sealed or unsealed internal environment for at least a piston 180 to continuously extend to an attachment point 182 outside the body housing 166. The piston 180 may comprise any number of components configured with unlimited sizes, shapes, and materials to span a predetermined distance in the mouth 160 and connect the eyelet 170 and archwire 168 with the attachment point 182. While not limiting, various embodiments tune the attachment point 182 as a hook, knob, or protrusion extending from a bracket 176 of a tooth of an upper jaw, as opposed to the teeth 178 of the lower jaw shown in FIG. 3. The interconnection of the upper and lower jaws by the piston 180 and eyelet 170 allows pressure to be continuously applied to the mouth 160 through the use of one or more compression members inside the body housing 166.

The application of compression inside the body housing 166 and pressure with the piston 180 can potentially distort the position and function of the body housing 166 due to its linear sidewalls 184. In other words, the piston 180 may be constructed of a flexible material, such as nylon, but may be oriented in positions that place undue stress on the body housing 166, cap 172, eyelet 170, and piston 180 in the event the linear sidewalls 184 restrict body housing 166 movement. Accordingly, the left-side dental appliance 164 illustrates a body housing 186 having sidewalls 188 configured with continuously curvilinear portions. The curvature of the body housing 186 can be tuned for fitment, comfort, and efficiency of pressure to the attachment point 182 by the piston 190.

The cap 192 can be configured to be having linear or curvilinear sidewalls that are similar or dissimilar to the body housing 186 of appliance 164. The cap 192 may have a size, shape, and fastening means that allow body housings 186 with differently curved and straight sidewalls to be combined without replacing the cap 192. The eyelet 194 may also be configured to be the same, or different, than eyelet 170. For example, eyelet 194 can have an aperture extending through the cap 192 at an angle that promotes eyelet 194 movement on the archwire 168 in a first direction, such as along the Y axis, while inhibiting eyelet 194 movement towards the front of the mouth 160. Such tuned configuration of the eyelet 194 and body housing 186 can allow the piston 190 to more efficiently apply pressure between the attachment point 182 and the archwire 168. The capacity to inhibit a user's ability to modify or remove the dental appliances 162 and 164 complements the tuned application of continuous pressure with the piston 190.

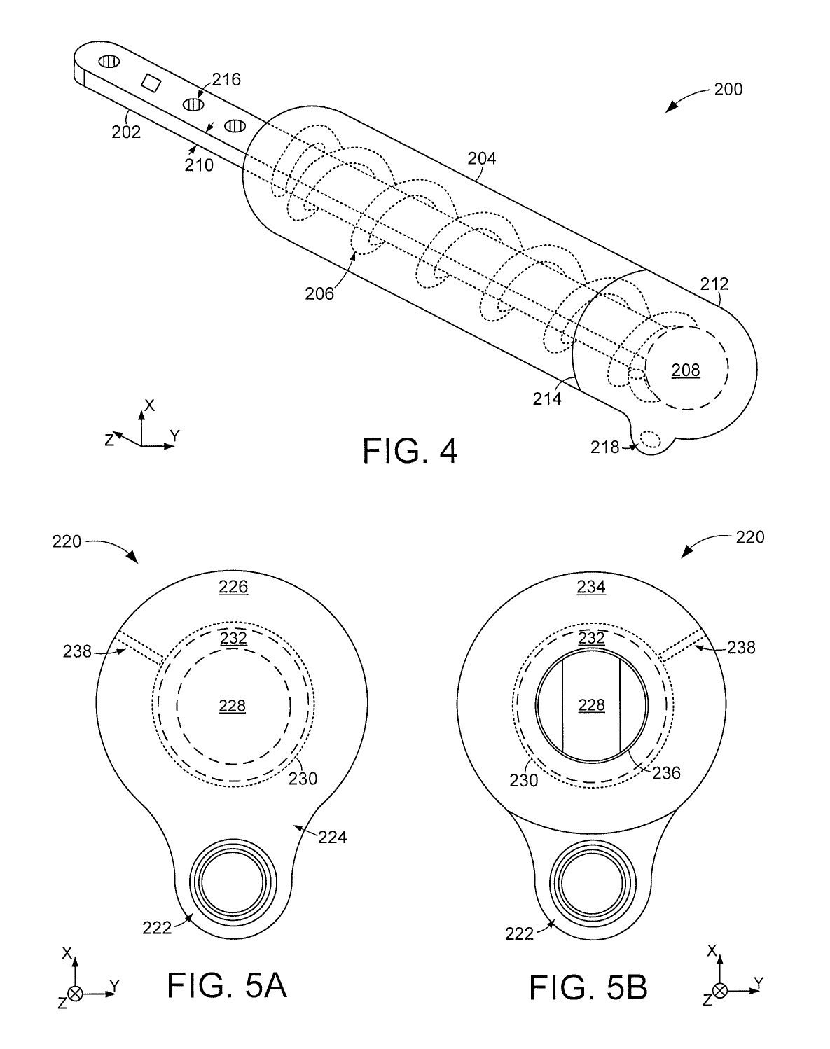

FIG. 4 displays an isometric view block representation of an example dental appliance 200 configured in accordance with assorted embodiments to provide consistent, uniform pressure on a piston 202. The dental appliance 200 has a body housing 204 that is hollowed to allow one or more compression members 206 to engage the piston 202, as illustrated by segmented lines corresponding to aspects of the appliance 200 residing within the body housing 204. The spring compression member 206 shown in FIG. 4 can be tuned for thickness, material, number of turns, and shape to provide a predetermined amount of pressure along the Z axis onto a pressure retention portion 208 of the piston 202.

That is, the piston 202 can be tuned to have a thickness 210 and a pressure retention portion 208, such as the spherical bulb shown in FIG. 4, which cooperates with the compression member 206 to provide consistent pressure along the Z axis. The cap 212 may connect with the body housing 204 via a seam 214 to ensure the compression member 206 and piston 202 do not disconnect from the body housing 204. In other words, the cap 212 can provide a backstop so that the compression member 206 does not overextend or dislodge from the pressure retention portion 208 during movement of a user's jaws.

The piston 202 may further be configured with any number of connection apertures 216 that can facilitate attachment to various hooks, knobs, and protrusions from brackets, bands, and wires of dental braces. In some embodiments, the attachment apertures 216 are tuned to be different sizes and shapes to allow temporary connection with different aspects of a user's orthodontic equipment, such as a bracket hook. It can be appreciated that the rigid and temporary connection to a tooth afforded by the attachment apertures 216 operate to complement the range of motion and permanent connection of the cap eyelet 218 to an archwire to restrict user tampering, promote user comfort, and optimize dental appliance efficiency.

FIGS. 5A and 5B respectively show front and rear plan views of an example dental appliance 220 that can be utilized in a dental system in accordance with various embodiments. The rear plan view of FIG. 5A illustrates how an eyelet 222 can be positioned within a protrusion 224 of a cap 226. The eyelet 222 can have rectangular or curvilinear shaped sidewalls that can promote and restrict movement of the cap 226 relative to an archwire extending through the eyelet 222. The rear view further illustrates how the cap 226 can contain a circular piston 228 that terminates in a blub 230 that retains a spring compression member 232. The circular shape of the piston 228 can be an unlimited variety of shapes and sizes that optimize the manner in which pressure is applied from the compression member 232 to the bulb 230 and piston 228.

FIG. 5B illustrates a front view of the dental appliance 220 and how the piston 228 can continuously extend from inside the body housing 234 to outside the body housing 234 via a piston aperture 236. The piston aperture 236 can be configured to provide a sealed or unsealed interface between the inside and outside of the body housing 234. The piston aperture 236, in some embodiments, is partially or completely filled with a waterproof material, such as rubber, silicon, or a polymer, that allows movement of the piston 228 while separating the inside of the body housing 234 from the user's mouth environment. Such separation of the body housing 234 can allow a lubricating fluid, such as saliva, to lubricate the movement of the compression member 232 and ensure continual, uniform application of pressure onto the piston 228.

It is contemplated that the body housing 234 and/or cap 226 can incorporate one or more apertures that continuously extend to the inside of the body housing 234. At least one aperture may be tuned for position and size to deliver cavity fighting ingredients at a predetermined rate to the user's mouth over time. For example, one or more cavity fighting ingredients, such as calcium, phosphate, and fluoride ions (anti-cariogenic ions), may be injected into the body housing 234 without having to take apart the appliance 220 at each dental appointment. The ability to utilize the rhythmic and sporadic movement of the piston 228 to force cavity fighting ingredients from inside the body housing 234 to the user's mouth allows for a diverse variety of long-term dental treatments and maintenance.

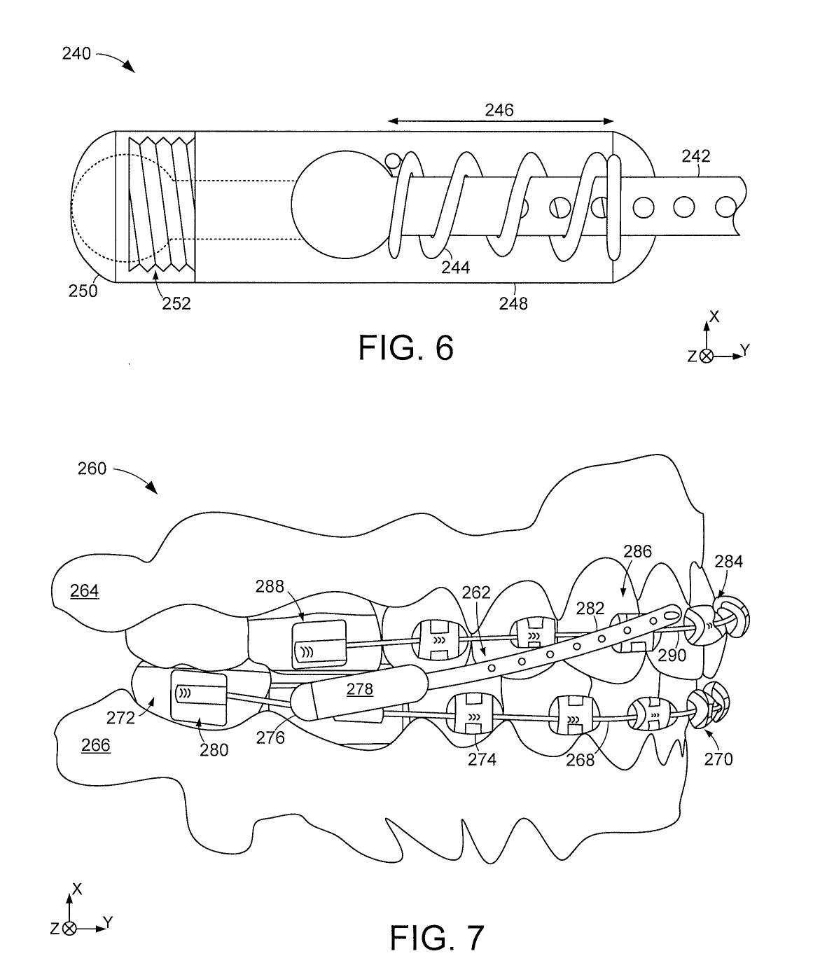

FIG. 6 is a cross-sectional view block representation of an example dental appliance 240 constructed and operated in accordance with assorted embodiments. The dental appliance 240 may be attached to an attachment point, such as a bracket hook or a hook attached to an archwire, via the piston 242. Attachment of the piston 242 to the attachment point allows the piston 242 to apply pressure onto the spring compression member 244 along direction 246. The compression member 244 can be tuned to have a spring rate that can accommodate a user's movement and continually apply pressure in the opposite direction by compressing the tension member 244 against the body housing 248.

The compression of the compression member 244 can be tuned to restrict piston 242 movements that could endanger the integrity of the dental appliance 240. For example, the compression member 244 may be tuned with a spring rate that greatly increases pressure applied to the piston 242 when the piston 242 is more than 75% extended towards the cap 250, as illustrated by segmented lines that correspond with no compression load being applied to the position 242. The compression member 244 may also be tuned to be under no compression, and hence apply little to no pressure onto the piston 242, when the piston 242 is 75% or more contained in the body housing 248. Such tuned configuration can allow a professional to disconnect the body housing 248 from the cap 250 without the body housing 248 being under a load.

The ability to disconnect the cap 250 from the body housing 248 by manipulating the threaded fastener 252 allows the piston 242 and compression member 244 to be inspected, repaired, and replaced without disconnecting the cap 250 from an archwire. For instance, an orthodontic treatment may employ different amounts of pressure to be applied by the piston 242 and compression member 244, which can be facilitated by modifying or replacing the piston 242 and compression member 244 before, during, and after the dental appliance 240 has been installed and has applied pressure on a user's mouth. The modular design of the dental appliance 240 can allow a professional to cater a user's orthodontic treatment to observed and scheduled progression to optimize the efficiency of a dental system, which may involve moving teeth, and modifying a user's palate.

With the ability to tune the construction and operation of the dental appliance 240, implementation of the appliance 240 into a dental system can provide comprehensive orthodontic treatment for a user. FIG. 7 displays a side view block representation of an example dental system 260 that employs at least one dental appliance 262 to apply pressure between upper 264 and lower 266 jaws of a user. The dental appliance 262 is connected to a wire 268 of bottom braces 270 between a band 272 and a bracket 274 by an eyelet of the appliance cap 276. The eyelet can allow movement of the cap 276 and attached appliance body 278 between the wire terminal 280 and the bracket 274, which allows for comfortable talking, eating, and sleeping.

As illustrated in FIGS. 4-6, the appliance body 278 can house at least one compression member that applies pressure against the flexible piston 282. The flexible piston 282 can, in various embodiments, attach to any portion of the top braces 284, such as a bracket hook 286, band 288, and wire 290, to provide an anchor point on the top braces 284 to facilitate movement of the top jaw 264 in relation to the bottom jaw 266. Although not limiting, the embodiment shown in FIG. 7 positions the dental appliance 262 to connect to the cuspid or incisor of the top jaw 264 and between the first and second molars of the lower jaw 266. Such configuration can apply pressure in multiple different directions that can effect long-term change in the bite and alignment of the lower 266 and upper 264 jaws.

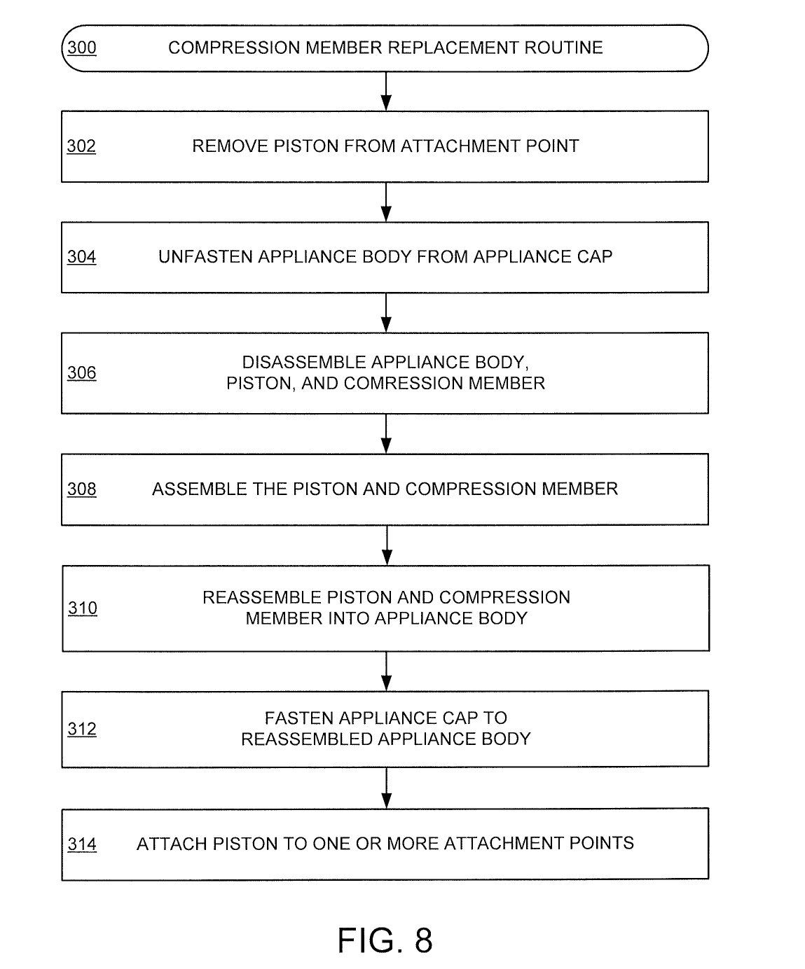

The orthodontic treatment afforded by the dental appliance 262 as part of the dental system 260 can be optimized by disconnecting the piston 282 from the bracket hook 286, unfastening the appliance cap 276 from the body 278, and replacing the compression member and/or piston 282. The ability to modify the strength of the dental appliance 262 and amount of pressure applied to the upper 264 and lower 266 jaws can efficiently provide orthodontic results without undue pain or discomfort. FIG. 8 is a flowchart of an example compression member replacement routine 300 that can be carried out, in some embodiments, after braces and at least one dental appliance have been installed into the mouth of a user.

Initially, step 302 disconnects a piston of a dental appliance from an attachment point in the top or bottom braces. Step 302 may entail the destruction of some or all of the piston to facilitate removal. While the piston is disconnected, the dental appliance remains attached to the wire of the top or bottom braces. Such connection allows the appliance body to be unfastened from the appliance cap in step 304 with tools or a professional's hands. Step 306 next disassembles the appliance body, piston, and compression member before step 308 assembles a piston and compression member to be housed in the appliance body. It is contemplated that step 308 can employ a piston and compression member that are respectively new or old. For example, a new compression member can be fit to a previously installed piston just as a new piston may be fit to a new compression member to facilitate a new pressure profile to be applied to the upper and lower jaws of a user.

Routine 300 can proceed to reassemble the piston and compression member into the appliance body in step 310. Step 312 then fastens the reassembled appliance body to the appliance cap before step 314 attaches the piston to a selected portion of the top or bottom braces. It should be noted that routine 300 can be repeated or may concurrently be conducted to replace the compression member in another dental appliance of the same mouth. The ability to tune different dental appliances to be the same or different through the use of different pistons and/or compression members can provide a wide range of orthodontic treatments to correct a variety of dental conditions, such as over-bite, cross-bite, and under-bite.

While routine 300 can provide the ability to tune orthodontic treatment, the routine 300 is not limited to the various steps shown in FIG. 8. As such, any of the steps can be changed, moved, and removed while additional steps may be conducted, without limitation. For example, additional steps may be added to routine 300 that install an additional dental appliance to a user's mouth, change piston thickness, and modify an appliance body shape.

Through the tuned configuration of at least one dental appliance in combination with dental braces, a dental system can be established that provides efficient orthodontic treatment. The ability to attach a dental appliance to the wire of a lower jaw and to a bracket hook of an upper jaw can operate concurrently with one or more compression members to allow comfortable interaction of the user's jaw while applying continuous pressure to modify the alignment of the upper and lower jaws. Additionally, construction of the dental appliance with a cap and body housing provides the ability to disassemble portions of the dental appliance for efficient inspection, repair, and replacement of various appliance components while maintaining an attached connection with the wire that inhibits user tampering with the dental system.

While the embodiments herein have been directed to lower and upper jaws of a user, it will be appreciated that the claimed technology can readily be utilized in any number of other configurations, such as the cap being connected to an archwire of an upper jaw. It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

1. An apparatus comprising:
a housing comprising a cap connected to a body via a fastener to enclose a first end of a piston, the cap having an eyelet engaging a wire of a first dental assembly, the piston positioned within the housing and comprising a flexible material continuously extending from the housing to engage a mount of a second dental assembly with one of a plurality of apertures extending through the piston, the housing having at least one aperture continuously extending from an internal cavity of the housing to an outside environment to allow a cavity fighting ingredient stored in the internal cavity to be delivered to the outside environment at a predetermined rate over time; and
a compression member enclosed within the housing and contacting the first end of the piston and the body of the housing, the compression member configured to compress along a first axis independent of movement by the body, the piston flexed along a second axis, perpendicular to the first axis, to apply continuous pressure on the piston in a selected direction parallel to the first axis.

2. The apparatus of claim 1, wherein the compression member encircles the piston.

3. The apparatus of claim 1, wherein the compression member comprises a metal spring.

4. The apparatus of claim 1, wherein the piston comprises nylon.

5. The apparatus of claim 1, wherein the piston comprises a pressure retention portion sized to retain the compression member about the piston.

6. The apparatus of claim 1, wherein the housing has curvilinear sidewalls along a longitudinal axis of the housing.

7. The apparatus of claim 1, wherein the housing is hollow and the compression member resides completely within the housing.

8. The apparatus of claim 1, wherein the housing has a smaller length than the piston.

9. The apparatus of claim 1, wherein the piston continuously extends from within the housing to outside the housing via a piston aperture in the housing.

10. The apparatus of claim 1, wherein first and second apertures of the plurality of apertures are different shapes.

11. An apparatus comprising:
a housing comprising a cap fastened to a body to seal a spherical bulb portion of a piston within the housing, the cap engaging a wire of a first dental assembly with an eyelet; the piston positioned within the housing and comprising a flexible material continuously extending from the housing to engage a mount of a second dental assembly with one of a plurality of apertures extending through the piston, the housing having at least one aperture continuously extending from an internal cavity of the housing to an outside environment to allow anti-cariogenic ions stored in the internal cavity to be delivered to the outside environment at a predetermined rate over time; and
a compression member enclosed within the housing and contacting the spherical bulb portion of the piston and the body of the housing, the compression member configured to compress along a first axis independent of movement by the body, the piston flexed along a second axis, perpendicular to the first axis, to apply continuous pressure on the piston in a selected direction parallel to the first axis.

12. The apparatus of claim 11, wherein the eyelet continuously protrudes from the cap.

13. The apparatus of claim 12, wherein the cap fastens to the housing body via a threaded connection.

14. The apparatus of claim 12, wherein the eyelet is an aperture through a protrusion in the cap.

15. The apparatus of claim 12, wherein the cap is hollow and configured to surround the piston and compression member.

16. A method comprising:
enclosing a first piston and compression member within a first housing by fastening a cap to a body;
engaging a wire of a first dental assembly with the first housing;
engaging a first mount of a second dental assembly with one of a plurality of apertures extending through the first piston, the first piston comprising a flexible material and continuously extending from the housing to the first mount;
applying pressure on the first piston along a first axis, the compression member compressing parallel to the first axis independent of movement of the first housing, the first piston flexed along a second axis, perpendicular to the first axis; and
delivering a cavity fighting ingredient from an internal cavity of the housing to an outside environment at a predetermined rate over time; the cavity fighting ingredient stored in the internal cavity and delivered via at least one aperture continuously extending from the internal cavity to the outside environment.

17. The method of claim 16, wherein the first dental assembly attaches to the wire of the first dental assembly via an eyelet of the second portion of the first housing and to an attachment point of a second dental assembly via the piston.

18. The method of claim 16, further comprising disassembling the cap and body of the first housing while the second portion of the first housing remains connected to the first dental assembly.

19. The method of claim 17, wherein the first compression member has a first spring rate and a second compression member with a second spring rate replaces the first compression member before the cap and body of the first housing are reassembled.

20. The method of claim 16, wherein a second housing engages the wire of the first dental assembly and a second piston positioned within the second housing is attached to a second mount of the second dental assembly, the first and second housings applying continuous pressure between the first and second dental assemblies concurrently.
